(19) United States
(12) Patent Application Publication
(10) Pub. No.: US 2005/0268626 A1
(43) Pub. Date: Dec. 8, 2005

(54) Method and apparatus for controlling freezing nucleation and propagation

(75) Inventors: Girish Upadhya, Cupertino, CA (US); Richard Grant Brewer, Newark, CA (US); Mark McMaster, Menlo Park, CA (US)

Correspondence Address: HAVERSTOCK & OWENS LLP, 162 NORTH WOLFE ROAD, SUNNYVALE, CA, 94086, US

(73) Assignee: Cooligy, Inc.

(21) Appl. No.: 11/049,202

(22) Filed: Feb. 1, 2005

Related U.S. Application Data
(60) Provisional application No. 60/577,262, filed on Jun. 4, 2004.

(51) Int. Cl. A21D 2/00; A21D 8/02; F25D 21/00

(52) U.S. Cl. 62/150

(57) ABSTRACT

An apparatus and method of controlling freezing in a liquid system is disclosed. The apparatus includes a heat exchanger having a initial zone characterized by a surface area to volume ratio. The apparatus also includes means for initiating freezing of a fluid from the initial zone to facilitate volume expansion during freezing in the direction of a final zone characterized by a final zone surface area to volume ratio. The apparatus can further include a plurality of zones located between the initial zone and the final zone, wherein a zone surface area to volume ratio is calculated for each zone. Preferably, the zone surface area to volume ratio of each zone progressively decreases from the initial zone in the direction of the final zone. Preferably, the final freezing zone has the lowest surface area to volume ratio and has sufficient elasticity to accommodate the volume expansion of all the fluid that has frozen from the initial zone.

### RELATED APPLICATION

This application claims priority under 35 U.S.C. § 119(e) of the co-pending U.S. provisional patent application Ser. No. 60/577,262, filed on Jun. 4, 2004, and titled “MULTIPLE COOLING TECHNIQUES.” The provisional patent application Ser. No. 60/577,262, filed on Jun. 4, 2004, and titled “MULTIPLE COOLING TECHNIQUES” is hereby incorporated by reference.

### FIELD OF THE INVENTION

The present invention relates generally to an apparatus and method of controlling freezing in a liquid system, such as may be useful for transferring heat from electronic devices and components thereof. In particular, the invention protects against expansion of fluid during freezing by initiating the expansion of frozen fluid in the direction of zones having progressively decreasing surface area to volume ratios.

### BACKGROUND OF THE INVENTION

Freezing is a transient non-equilibrium process, during which phase change occurs with release of latent heat as liquid or fluid cools below freezing temperature due to ambient cooling conditions. When water or some water based-mixtures are cooled below freezing, the material changes from a liquid state to a solid state, and undergoes a significant expansion in volume, which is as much as 10% or more for water or water-based mixtures. When water freezes in a pipe or other confined spaces, its volume expands. Water that has frozen in confined spaces does more than simply clog the pipes and block flow. When freezing occurs in a confined space like a steel pipe, the ice will expand and exert extreme pressure which often leads to bursting of the pipe or separation of a joint and cause serious damage. This phenomenon is a common failure mode in hot-water heating systems and automotive cooling systems.

Ice forming in a confined space does not always cause cracking where ice blockage occurs. Rather, following a complete ice blockage in a confined space, continued freezing and expansion inside the confined space can cause water pressure to increase downstream, which could lead to pipe failure and/or cracking in these areas. Upstream from the ice blockage the water can retreat back towards its inlet source, and there is little pressure buildup to cause cracking. Relative to other liquids, water-based mixtures are preferred for use in liquid cooling systems due to advantages in thermal properties and health and safety concerns.

Liquid cooling systems for electronic devices are occasionally subjected to sub-freezing environments during shipping, storage, or in use. If the liquid freezes, the system must be designed to tolerate any volume expansion that would occur. Additives used to lower the freezing point, such as antifreeze, are potentially poisonous and flammable and can damage mechanical components, sensitive sensors, and electronics.

Therefore, to use pure water or substantially pure water in such a system, an apparatus for and method of controlling freezing nucleation and propagation is needed, such that the system can tolerate the volume expansion caused by freezing of the aforementioned fluid without damaging electronic components or affecting system performance.

### SUMMARY OF THE INVENTION

The present invention protects components and pipes of a liquid cooling system from cracking related to an expansion of volume due to freezing of the fluid within the system. In particular, the present invention provides an apparatus for and method of controlling freezing nucleation and propagation in a liquid system having one or more components coupled and characterized by a plurality of surface area to volume ratios so that when freezing occurs, the fluid expands from an initial zone having a highest surface area to volume ratio in the direction of one or more zones having progressively decreasing surface area to volume ratios. Thus, the present invention manages and designs surface area to volume ratios of one or more components as well as regions within the components, including heat exchangers, inlet and outlet ports and tubular members, so that when freezing occurs, the volume expands in the direction that can accept the expanded volume.

In accordance with one embodiment of the present invention, an apparatus for controlling freezing nucleation and propagation in a liquid system is disclosed. The apparatus includes a heat exchanger having multiple zones characterized by surface area to volume ratio. The apparatus also includes means for initiating freezing of a fluid from an initial zone which results in volume expansion during freezing through the multiple zones having progressively lower surface area to volume ratios in the direction of a member having a final zone characterized by a final surface area to volume ratio. Alternatively, the heat exchanger can be replaced by any member in a liquid system.

In accordance with the present invention, the surface area to volume ratio of the final zone is preferably lower than the surface area to volume ratio of the initial zone. For a water based system the final zone can accommodate an expanded volume of at least 10% of all the liquid volume present in each zone, including the final zone, when the fluid freezes. For example, the final zone can be a tubular member. In one embodiment, the tubular member can have elasticity sufficient to expand outwardly to accommodate the volume expansion caused by the freezing of the fluid.

In the preferred embodiment, the initial zone is internal to a heat exchanger. The heat exchanger can include an inlet port extending through a first opening of the heat exchanger for conveying the fluid to a plurality of channels and passages and an outlet port extending through a second opening for discharging the fluid from the plurality of channels and passages. The plurality of channels and passages can be formed in porous copper foam. Alternatively, the plurality of channels and passages can be formed of microchannels. Alternatively, the plurality

Multiple fluid pathways emanating from the initial zone may necessitate identification of multiple zones. In one embodiment, the apparatus includes a plurality of zones located between the initial and final zones, wherein a zone surface area to volume ratio is calculated for each zone. Preferably, the zone surface area to volume ratio of each zone progressively decreases from the initial zone in the direction of the final zone.

The apparatus can include one or more compressible objects coupled within the final zone wherein pressure exerted on the compressible object by the freezing fluid increases a volume of the final zone. The compressible objects are preferably confined within the final zone. The compressible objects can be made of one of the following: sponge, foam, air-filled bubbles, and balloons. Preferably, the sponge and foam are hydrophobic.

The apparatus can also include at least one air pocket disposed in the final zone wherein the air pocket accommodates the expansion by the freezing fluid. Alternatively, the apparatus can include at least one flexible object coupled to the final zone wherein pressure exerted on the flexible object by the freezing fluid increases a volume of the final zone. Preferably, the flexible object is secured within the final zone. The flexible object can be made of one of the following: rubber, plastic, and foam.

In accordance with another embodiment of the present invention, a method of controlling freezing nucleation and propagation in a liquid system is disclosed. The method comprises the steps of initiating freezing of fluid from an initial zone of a heat exchanger and characterized by an initial surface area to volume ratio; and directing the frozen fluid to a final zone which is a tubular member characterized by a final surface area to volume ratio.

### BRIEF DESCRIPTION OF THE DRAWINGS

FIG. 1 illustrates one embodiment of a closed-loop fluid system for implementing embodiments of the present invention.

FIG. 2 illustrates one embodiment of a heat exchanger divided into logical zones characterized by surface area to volume ratios, in accordance with the present invention.

### DETAILED DESCRIPTION OF THE PREFERRED EMBODIMENT

Reference will now be made in detail to the preferred and alternative embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it should be noted that the present invention can be practiced without these specific details. In other instances, well known methods, procedures and components have not been described in detail as not to unnecessarily obscure aspects of the present invention.

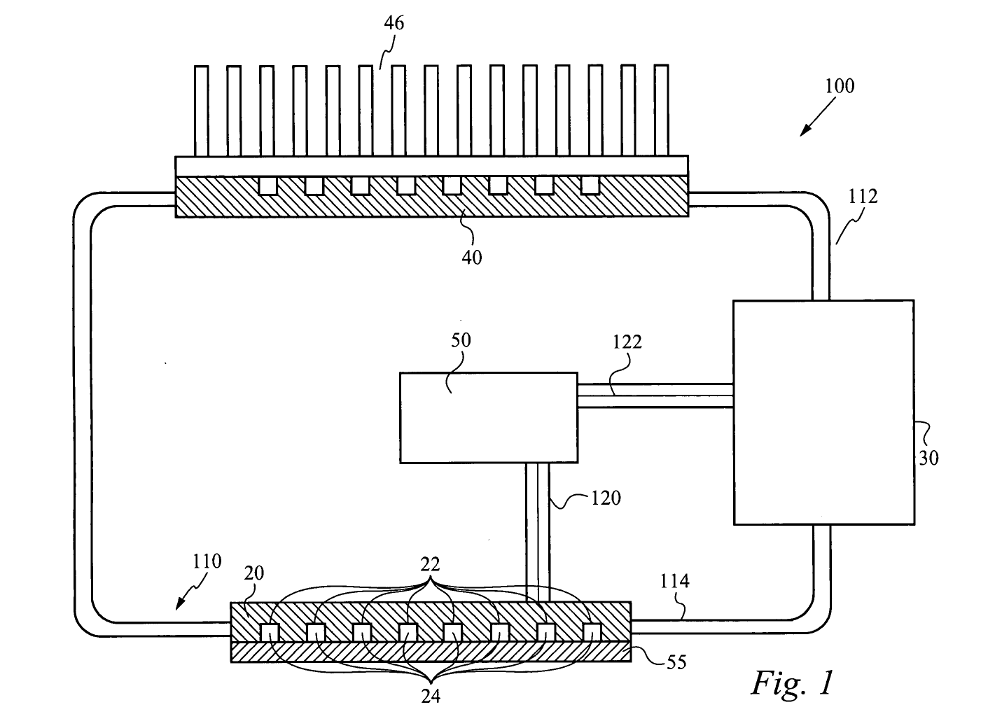

FIG. 1 shows a schematic diagram of a closed-loop fluid system 100 for implementing embodiments of the present invention. The system 100 includes a heat exchanger 20 attached to a heat producing device 55 (shown as an integrated circuit attached to a circuit board, but which could also be a circuit board or other heat producing device), a pump 30 for circulating fluid, a heat rejector 40, which can include a plurality of fins 46 for further assisting in conducting heat away from the system 100, and a controller 50 for a pump input voltage based on a temperature measured at the heat exchanger 20.

Fluid flows from an inlet of the pump 30, passes through a porous structure (not shown) within the pump 30 by electroosmotic forces, and exits through an outlet of the pump 30. While this embodiment uses an electroosmotic pump, it will be understood that the present invention can be implemented in a system using other types of pumps, such as a mechanical pump. The fluid travels through microchannels 24 of the heat exchanger 20, the heat rejector 40, and through tubing lengths 114, 112 and 110 before being returned to the inlet of the pump 30. A spreader (not shown) is preferably coupled between the heat producing device 55 and the microchannels 24. The controller 50 is understood to be an electronic circuit that may take input signals from thermometers in the heat exchanger 20, or from thermometers in the device 55 being cooled, through which signals are transmitted along signal lines 120. The controller 50, based upon the input signals may regulate flow through the pump 30 by applying signals to a power supply (not shown) associated with the pump 30 along signal lines 122 to achieve the desired performance. While this embodiment specifies a flow direction, it will be understood that the present invention can be implemented with the reverse flow direction.

As fluid temperature drops below freezing, ice starts to form. The rate at which ice forms depends on the rate at which the fluid cools, which depends on a surface area to volume ratio. Continued growth of ice in areas of the system 100 can lead to excessive fluid pressure. The resulting pressure can rupture or damage individual elements, such as the microchannels 24, including walls 22 of the microchannels 24, in the heat exchanger 20 and the tubular members 110, 112 and 114. As will be explained and understood in further detail below, these elements are designed in a way that tolerates expansion of the fluid during freezing.

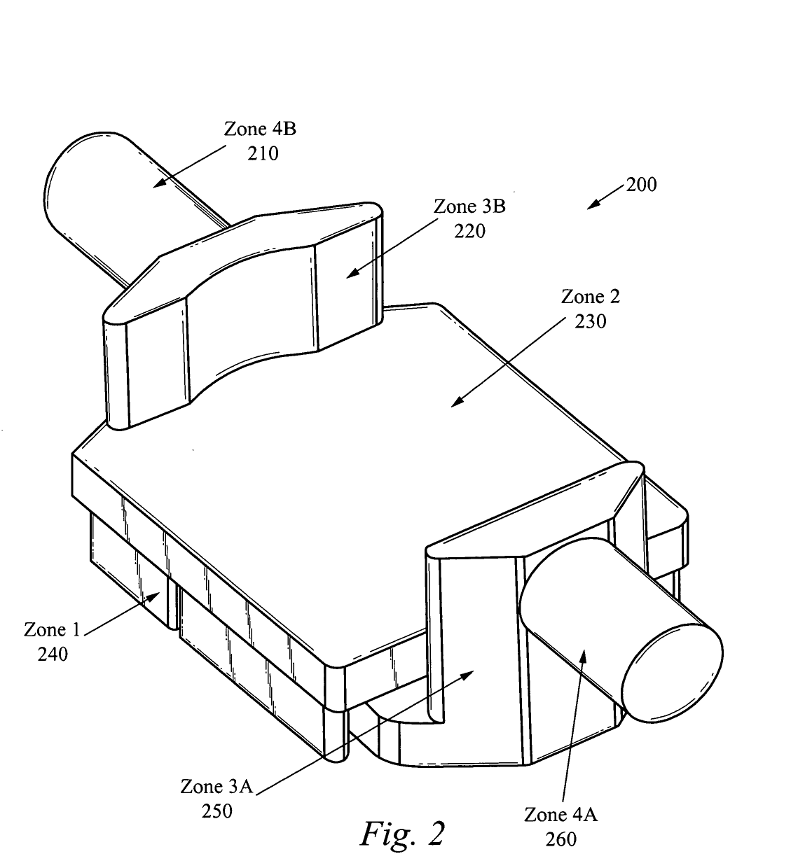

FIG. 2 illustrates one embodiment of a heat exchanger 200 divided into zones 1, 2, 3A and 3B and characterized by surface area to volume ratios. The heat exchanger 200 is coupled to tubular members 210 and 260 disposed in zone 4A and 4B, respectively, and also characterized by surface area to volume ratios. In this embodiment, zone 1 is the initial zone and the tubular members represent a final zone or zones. Zone 1 is preferably one or more microchannels (not shown) or a porous structure (not shown). Alternatively, Zone 1 can be one or more micropins (not shown). Surface areas are calculated for each zone, preferably based directly on model geometry. A zone can be constructed of one or more structures, such as copper foam, to have a desired surface area to volume ratio throughout the heat exchanger 200. Volumes are calculated for each zone, preferably based directly on model geometry. The surface to volume ratio of each zone is calculated by dividing the surface area of each zone by the volume of each zone. The resulting surface to volume ratio values of adjacent zones are compared. Freeze progression is deemed favorable when the surface area to volume ratio of the heat exchanger 200 progressively decreases outward from zone 1 to the tubular members at the onset of freezing. In particular, the surface area to volume ratio of zone 1 is relatively high and the surface area to volume ratios of the tubular members (zones 4A, 4B) are relatively low.

During freezing, the fluid expands from a zone having the highest surface area to volume ratio in the direction of one or more zones having progressively decreasing surface area to volume ratios. It will be appreciated that the heat exchanger 200, including the tubular members 210 and 260, can include many zones each with a different surface area to volume ratio. The zone surface area to volume ratio of adjacent zones progressively decreases from the heat exchanger 200 in the direction of the tubular members 210 and 260; the zone surface area to volume ratio decreases in the following order of zones: 1>2>3B>4B and 1>2>3A>4A. In this embodiment, the tubular members 210 and 260 are designed to accommodate the necessary volume expansion.

The tubular members 210 and 260 preferably include compliant materials to accommodate an expanded volume of at least 10% when the fluid freezes. Preferably, the tubular members 210 and 260 have elasticity sufficient to expand outwardly to accommodate the volume expansion caused by the freezing of the fluid. Alternatively, the one or more compressible objects (not shown) can be coupled to the tubular member 210 and 260 wherein pressure exerted on the compressible object by the freezing fluid increases a volume of the tubular members 210 and 260. Preferably, the compressible objects (not shown) are confined within the tubular member and made of one of the following: sponge, foam, air-filled bubbles, sealed tubes and balloons. Other types of compressible objects can be used. The sponge and foam can be hydrophobic.

In another embodiment, at least one air pocket (not shown) can be disposed in the tubular members 210 and 260 wherein the air pocket (not shown) accommodates the expansion by the freezing fluid. Alternatively, at least one flexible object (not shown) is coupled to the tubular members 210 and 260 wherein pressure exerted on the flexible object (now shown) by the freezing fluid increases a volume of the tubular members 210 and 260. The flexible object (not shown) is preferably secured within the tubular member and made of one of the following: rubber, plastic, and foam. It will be appreciated that additional compliant materials may also be employed to withstand the expansion of freezing fluid.

This invention has been described in terms of specific embodiment in incorporating details to facilitate the understanding of the principles of construction and operation of the invention. Such reference herein to specific embodiment and the details thereof is not intended to limit the scope of the claims and hereto. It will be apparent to those of ordinary skill in the art that modifications can be made in the embodiment chosen for illustration without departing from the spirit and scope of the invention. Specifically, it will be apparent to one of ordinary skill in the art device of the present invention could be implemented in several different ways and the apparatus disclosed above is only illustrative of the before embodiment invention and is in no way limitation.

1. An apparatus for controlling freezing nucleation and propagation in a liquid system, comprising:
a. a member having an initial zone characterized by an initial surface area to volume ratio; and
b. means for initiating freezing of a fluid from the initial zone to facilitate volume expansion during freezing in a direction that progresses through a series of subzones, each characterized by calculated surface area to volume ratio, to a final zone characterized by a final zone surface area to volume ratio.

2. The apparatus of claim 1 wherein the member comprises a heat exchanger.

3. The apparatus of claim 1 wherein the final zone surface area to volume ratio is lower than the initial surface area to volume ratio.

4. The apparatus of claim 1 wherein the final zone accommodates an expanded volume when the fluid freezes.

5. The apparatus of claim 4 wherein the final zone resiliently expands.

6. The apparatus of claim 1 wherein at least one of the subzones is constructed of a structure to obtain a predetermined surface area to volume ratio.

7. The apparatus of claim 6 wherein the structure is a copper foam.

8. The apparatus of claim 1 wherein at least one of the zones is constructed of a structure to obtain a predetermined surface area to volume ratio.

9. The apparatus of claim 8 wherein the structure is a copper foam.

10. The apparatus of claim 2 wherein the heat exchanger includes an inlet port extending through a first opening of the heat exchanger for conveying the fluid to a plurality of channels and passages and an outlet port extending through a second opening for discharging the fluid from the plurality of channels and passages.

11. The apparatus of claim 10 wherein the heat exchanger includes multiple inlet ports and multiple outlet ports.

12. The apparatus of claim 1 wherein the calculated zone surface area to volume ratio of each subzone progressively decreases from the initial zone in the direction of the final zone.

13. The apparatus of claim 1 further including one or more compressible objects coupled to the final zone wherein pressure exerted on the compressible object by the freezing fluid increases a volume of the final zone.

14. The apparatus of claim 13 wherein the compressible objects are confined within the final zone.

15. The apparatus of claim 13 wherein the compressible objects are made of one of the following: sponge, foam, air-filled bubbles, sealed tubes and balloons.

16. The apparatus of claim 15 wherein the sponge is hydrophobic.

17. The apparatus of claim 15 wherein the foam is hydrophobic.

18. The apparatus of claim 1 further including at least one air pocket disposed in the final zone wherein the air pocket accommodates the expansion by the freezing fluid.

19. The apparatus of claim 1 further including at least one air pocket disposed along a freezing path in at least one of the zones and subzones.

20. A heat exchanger, comprising:
a. an initial zone characterized by a initial surface area to volume ratio; and
b. means for initiating freezing of a fluid from the initial zone to accommodate volume expansion during freezing in the direction of a final zone characterized by a final zone surface area to volume ratio.

21. The heat exchanger of claim 20 wherein the final zone surface area to volume ratio is lower than the initial surface area to volume ratio.

22. The heat exchanger of claim 20 wherein the final zone accommodates an expanded volume when the fluid freezes.

23. The heat exchanger of claim 20 wherein the heat exchanger includes an inlet port extending through a first opening of the heat exchanger for conveying the fluid to a plurality of microstructures and an outlet port extending through a second opening for discharging the fluid from the plurality of channels and passages.

24. The heat exchanger of claim 23 wherein the heat exchanger includes multiple inlet ports and multiple outlet ports.

25. The heat exchanger of claim 20 wherein the final zone elasticity is sufficient to expand outwardly to accommodate the volume expansion caused by the freezing of the fluid.

26. The heat exchanger of claim 20 further including a plurality of subzones located between the initial zone and the final zone, wherein a zone surface area to volume ratio of each subzone progressively decreases from the initial zone in the direction of the final zone.

27. The heat exchanger of claim 26 wherein at least one of the subzones is constructed of a structure to obtain a predetermined surface area to volume ratio.

28. The heat exchanger of claim 27 wherein the structure is a copper foam.

29. The heat exchanger of claim 20 wherein at least one of the zones is constructed of a structure to obtain a predetermined surface area to volume ratio.

30. The heat exchanger of claim 29 wherein the structure is a copper foam.

31. The heat exchanger of claim 20 further including one or more compressible objects coupled to the tubular member wherein pressure exerted on the compressible object by the freezing fluid increases a volume of the final zone.

32. The heat exchanger of claim 31 wherein the compressible objects are made of one of the following: sponge, foam, air-filled bubbles, sealed tubes and balloons.

33. The heat exchanger of claim 32 wherein the sponge is hydrophobic.

34. The heat exchanger of claim 32 wherein the foam is hydrophobic.

35. The heat exchanger of claim 20 further including at least one air pocket disposed in the final zone wherein the air pocket accommodates the expansion by the freezing fluid.

36. The heat exchanger of claim 20 further including at least one air pocket disposed along a freezing path in at least one of the zones and subzones.

37. A heat exchanger, comprising:
a. an inlet port extending through a first opening of the heat exchanger for conveying a fluid to a plurality of channels and passages;
b. an outlet port extending through a second opening for discharging the fluid from the plurality of channels and passages; and
c. means for initiating freezing from an initial zone of the heat exchanger characterized by an initial zone surface area to volume ratio to facilitate volume expansion during freezing in the direction of the inlet and outlet ports to a tubular member having a final zone characterized by a final zone surface area to volume ratio lower than the initial zone surface area to volume ratio.

38. The heat exchanger of claim 37 wherein the final zone elasticity is sufficient to expand outwardly to accommodate the volume expansion caused by the freezing of the fluid.

39. The heat exchanger of claim 37 further including a plurality of subzones located between the initial zone and the final zone, wherein a zone surface area to volume ratio of each subzone progressively decreases from the initial zone in the direction of the final zone.

40. The heat exchanger of claim 39 wherein at least one of the subzones is constructed of a structure to obtain a predetermined surface area to volume ratio.

41. The heat exchanger of claim 40 wherein the structure is a copper foam.

42. The heat exchanger of claim 37 wherein at least one of the zones is constructed of a structure to obtain a predetermined surface area to volume ratio.

43. The heat exchanger of claim 42 wherein the structure is a copper foam.

44. The heat exchanger of claim 37 wherein the heat exchanger includes multiple inlet ports and multiple outlet ports.

45. A method of controlling freezing nucleation and propagation in a liquid system, comprising the steps of:
a. initiating freezing of fluid from an initial zone of a heat exchanger and characterized by a an initial zone surface area to volume ratio; and
b. directing the frozen fluid to a final zone characterized by a final, lower, surface area to volume ratio.

46. The method of claim 45 wherein the final zone accommodates an expanded volume when the fluid freezes.

47. The method of claim 45 wherein the heat exchanger includes an inlet port extending through a first opening of the heat exchanger for conveying the fluid to a plurality of channels and passages and an outlet port extending through a second opening for discharging the fluid from the plurality of channels and passages.

48. The method of claim 47 wherein the heat exchanger includes multiple inlet ports and multiple outlet ports.

49. The method of claim 45 wherein the final zone elasticity is sufficient to expand outwardly to accommodate the volume expansion caused by the freezing of the fluid.

50. The method of claim 45 wherein a plurality of subzones are located between the initial zone and the final zone, and wherein a zone surface area to volume ratio of each subzone progressively decreases from the initial zone in the direction of the final zone.
